(19) United States
(12) Patent Application Publication
(10) Pub. No.: US 2025/0337067 A1
(43) Pub. Date: Oct. 30, 2025

(54) BATTERY HOLDER WITH PLUG

(71) Applicant: LOTES CO., LTD, Keelung (TW)

(72) Inventors: Pei-Yu Lou, Guangzhou (CN); Jun-Kang Zhong, Guangzhou (CN); Wei He, Guangzhou (CN)

(21) Appl. No.: 19/026,875

(22) Filed: Jan. 17, 2025

(30) Foreign Application Priority Data
Apr. 26, 2024 (CN) 202420896833.X

(51) Int. Cl. H01M 50/202; H01M 50/109; H01M 50/242; H01M 50/262; H01M 50/291; H01R 13/424

(52) U.S. Cl. CPC H01M 50/202; H01M 50/242; H01M 50/262; H01M 50/291; H01M 50/109; H01R 13/424

(57) ABSTRACT

A battery holder, in which a limiting portion of a plug is inserted downward into a space between the retaining portion and the elastic arm to stop the elastic arm from excessively deviating toward a direction away from the battery, thus retaining the battery in the accommodating space, and preventing the battery from falling from the accommodating space. A gap exists between the limiting portion and the contact section or the contact spring arm, thus preventing the plug from abutting against the contact section or the contact spring arm in the inserting or pulling process, such that the contact section or the contact spring arm maintains elastically abutting against the battery.

### CROSS-REFERENCE TO RELATED PATENT APPLICATION

This non-provisional application claims priority to and the benefit of, pursuant to 35 U.S.C. § 119 (a), patent application Serial No. CN202420896833.X, filed in China on Apr. 26, 2024. The disclosure of the above application is incorporated herein in its entirety by reference.

Some references, which may include patents, patent applications and various publications, are cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference were individually incorporated by reference.

### FIELD

The present invention relates to a battery holder with a plug, and particularly to a battery holder in which a plug stops a positive elastic sheet to stably maintain the battery.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

An existing button battery holder, which is applied in an electronic equipment, is used to accommodate a battery. The battery holder includes a holder body and a positive elastic sheet and a negative elastic sheet accommodated in the holder body. The positive elastic sheet is a U-shaped structure, and a side of the U-shaped structure of the positive elastic sheet facing toward the battery has a stopping portion abutting against an upper surface of the battery. The stopping portion is located at a top portion of the battery to stop the battery from moving upward, thus preventing the battery from falling from the holder body.

However, the positive elastic sheet is a U-shaped structure, which may elastically deviate easily. When the positive elastic sheet is subjected to an external force toward a direction away from the battery, the U-shaped structure of the positive elastic sheet may easily deviate, resulting in the stopping portion moving toward the direction away from the battery, such that the stopping portion is released from stopping the battery, and children may easily take out the battery, which may result in accidental ingestion of the battery by the children. In addition, in a high vibration environment, the elastic arm may deviate toward the direction away from the battery, resulting in the stopping portion to become ineffective in its stopping effect, such that the battery has the risk of falling out of the holder body.

Therefore, a heretofore unaddressed need to design an improved battery holder exists in the art to address the aforementioned deficiencies and inadequacies.

### SUMMARY

In view of the deficiencies of the background technology, the present invention is directed to a battery holder, in which the limiting portion of the plug is inserted downward into a space between the retaining portion and the elastic arm to limit the elastic arm from excessively deviating toward a direction away from the battery, thus retaining the battery in the accommodating space, preventing the children from accidentally contacting the elastic arm that results in the stopping portion and the elastic arm deviating altogether and failure of stopping the battery, preventing the battery from falling from the accommodating space, and ensuring the structural stability of the battery holder. Further, the original structure of the positive elastic sheet is maintained, which is conducive to saving the cost. Further, a gap exists between the limiting portion and the contact section or the contact spring arm, thus preventing the plug from colliding with the contact section or the contact spring arm in the inserting or pulling process that may result in elastic fatigue or deviation damages of the contact section or the contact spring arm, such that the contact section or the contact spring arm maintains elastically abutting against the battery, ensuring the stability of the electrical connection between the contact section or the contact spring arm and the battery.

To achieve the foregoing objective, the present invention adopts the following technical solutions. A battery holder is used to accommodate a battery. The battery holder includes: a holder body, having a bottom wall and a side wall extending upward from the bottom wall and surrounding the bottom wall, wherein the bottom wall and the side wall collectively form an accommodating space to accommodate the battery, the holder body is provided with a receiving slot along an up-down direction, and the receiving slot is in communication with the accommodating space; a positive elastic sheet and a negative elastic sheet, respectively accommodated in the holder body and electrically connected to the battery, wherein the positive elastic sheet comprises a retaining portion fixed in the receiving slot, a connecting portion connected to a lower end of the retaining portion and an elastic arm extending upward from the connecting portion, the elastic arm is exposed in the accommodating space, the retaining portion is located at a side of the elastic arm away from the accommodating space, the elastic arm is provided with at least one stopping portion extending toward the accommodating space, the stopping portion stops the battery from moving upward, the elastic arm has a contact section, and the contact section extends obliquely toward the accommodating space to elastically abut against the battery; and a plug, having a limiting portion, wherein the limiting portion is inserted downward into a space between the retaining portion and the clastic arm, in a horizontal direction, a gap exists between the limiting portion and the contact section, and the limiting portion is configured to stop the elastic arm from excessively deviating toward a direction away from the battery, and to retain the battery in the accommodating space.

In certain embodiments, a side of the side wall is provided with at least one protruding portion protruding toward the accommodating space, the protruding portion and the limiting portion are respectively located at two opposite sides of a horizontal central line of the accommodating space, and the protruding portion stops the battery from moving upward together with the stopping portion. In certain embodiments, the elastic arm has a limiting section located above the contact section, the limiting section is limited by the limiting portion, two opposite side edges of the limiting section bend and extend to form two stopping portions to collectively stop the top portion of the battery, and in the horizontal direction, a maximum distance between the limiting portion and the limiting section is less than an extending length of each of the stopping portions along the horizontal direction.

In certain embodiments, each of two sides of a top end of the limiting section respectively bends and extends toward the direction away from the accommodating space to form a blocking sheet, the two blocking sheets respectively abut against an outer surface of the side wall, the limiting portion has a first limiting surface and two second limiting surfaces, the first limiting surface faces directly toward the limiting section, the two second limiting surfaces respectively face directly toward the two blocking sheets, and in the horizontal direction, a distance between each second limiting surface and a corresponding blocking sheet is less than or equal to a distance between the first limiting surface and the limiting section. In certain embodiments, the retaining portion protrudes upward to form an extending portion, a rear side of the side wall is provided with a mounting portion protruding backward, the receiving slot is formed by running through the mounting portion along the up-down direction, the plug has a frame portion with a opening at a bottom end thereof, a front side of the frame portion is connected to the limiting portion, the frame portion is mounted downward and sleeved outside the mounting portion, each of two sides of the frame portion is provided with an abutting protrusion protruding downward to abut against an upper surface of the mounting portion, outer edges at a left side and a right side of the mounting portion collectively stop the frame portion from moving in a left-right direction, a top surface of the frame portion is provided with a positioning slot running downward therethrough, a rear wall of the mounting portion is provided with a positioning protrusion formed by protruding upward, and the extending portion and the positioning protrusion are both inserted into the positioning slot to collectively limit the frame portion in a front-rear direction.

In certain embodiments, the rear wall of the mounting portion is provided with a locking slot running forward and downward therethrough, the locking slot is in communication with the receiving slot, an upper edge of the locking slot is provided with an oblique surface, the retaining portion is provided with an engaging sheet extending upward, the upper edge of the locking slot is located at an upper side of the engaging sheet to stop the engaging sheet from moving upward, an inner side of the frame portion is provided with a locking arm extending downward and a locking hook protruding forward from a lower end of the locking arm, and the locking hook buckles with the oblique surface. In certain embodiments, the frame portion has a top plate, two side plates extending downward from the top plate and a rear plate connecting the two side plates, the limiting portion extends downward from a front side of the top plate and is provided to directly face the locking arm, the rear plate is located at a rear side of the locking arm and a gap exists between the rear plate and the locking arm, and an extending length of the rear plate in the up-down direction is greater than or equal to an extending length of the locking arm in the up-down direction.

In certain embodiments, the clastic arm, the connecting portion and the retaining portion collectively form a U-shaped structure with an opening at an upper end thereof, and the limiting portion is inserted downward into the opening and located between the retaining portion and the elastic arm. The present invention further provides a battery holder, which is used to accommodate a battery. The battery holder includes: a holder body, having a bottom wall and a side wall extending upward from the bottom wall, wherein the bottom wall and the side wall collectively form an accommodating space to accommodate the battery, the side wall is protrudingly provided with a mounting portion toward a direction away from the accommodating space, the mounting portion is provided with a receiving slot running therethrough along an up-down direction, and the receiving slot is in communication with the accommodating space; a positive elastic sheet and a negative elastic sheet, respectively accommodated in the holder body and electrically connected to the battery, wherein the positive elastic sheet comprises a retaining portion fixed in the receiving slot, a connecting portion connected to a lower end of the retaining portion and an elastic arm extending upward from the connecting portion, the elastic arm is exposed in the accommodating space, the retaining portion is located at a side of the elastic arm away from the accommodating space, the elastic arm is provided with a stopping portion extending toward the accommodating space, the stopping portion stops the battery from moving upward, a contact spring arm bends and extends from the retaining portion, and the contact spring arm is exposed to the accommodating space to elastically abut against a side surface of the battery; and a plug, having a limiting portion, wherein the limiting portion is inserted downward into a space between the retaining portion and the elastic arm, the limiting portion is configured to stop the clastic arm from excessively deviating toward a direction away from the battery, and to retain the battery in the accommodating space, and a reserved notch is concavely provided on a surface of the limiting portion facing the contact spring arm to provide a space for the contact spring arm.

In certain embodiments, a side of the side wall is provided with at least one protruding portion protruding toward the accommodating space, the protruding portion and the mounting portion are respectively located at two opposite sides of a horizontal central line of the accommodating space, and the protruding portion stops the battery from moving upward together with the stopping portion. In certain embodiments, middle portions of the connecting portion and the elastic arm are provided to be hollow, such that two limiting sections are formed respectively at a left side and a right side of the elastic arm, the contact spring arm bends and extends upward from a middle portion of a bottom end of the retaining portion, a portion of the contact spring arm is located in a hollow region at the middle portions of the connecting portion and the elastic arm, the limiting portion forms two abutting surfaces respectively at a left side and a right side of the reserved notch, and the two abutting surfaces respectively abut against the two limiting sections.

In certain embodiments, the receiving slot comprises a receiving channel located at a middle and in communication with the accommodating space, two recesses concavely provided at a left side and a right side of a front end of the receiving channel along a left-right direction respectively, and two retaining slots concavely provided at a left side and a right side of a rear end of the receiving channel along the left-right direction, the two limiting sections are one-to-one correspondingly located in the two recesses, inner surfaces of front ends of the two recesses correspondingly stop the two limiting sections from deviating toward the accommodating space, a middle portion of the retaining portion is accommodated in the receiving channel, and edges at a left side and a right side of the retaining portion are respectively fixed to the two retaining slots.

In certain embodiments, the limiting portion is provided to be wider at front thereof and narrower at rear thereof, the limiting portion has a first portion with a wider width and a second portion located at a rear side of the first portion and with a narrower width, the reserved notch is backward concavely provided from a front end of the first portion, the two abutting surfaces are respectively located at a left side and a right side of the front end of the first portion, the second portion is accommodated in the receiving channel, and inner surfaces at a left side and a right side of the receiving channel collectively stop the second portion from moving in the left-right direction.

In certain embodiments, a lower end of the limiting portion has a plurality of guiding surfaces obliquely upward, the first portion is provided with one of the guiding surfaces below each of the abutting surfaces, a side of a lower end of the second portion toward the retaining portion is provided with one of the guiding surfaces, and the guiding surfaces collectively guide the limiting portion to be inserted between the retaining portion and the elastic arm. In certain embodiments, the stopping portion is formed by bending and extending from an upper end of the elastic arm toward the accommodating space, a top end of the plug has a shielding portion, the shielding portion is located above the limiting portion, and in the up-down direction, the shielding portion shields an upper surface of the stopping portion. In certain embodiments, a rear side of the side wall is provided with the mounting portion protruding backward, the receiving slot is formed by running through the mounting portion along the up-down direction, the retaining portion is provided with a cutout running therethrough along the horizontal direction, an engaging sheet integrally extends upward from a lower edge of the cutout, a stopping block is protrudingly provided on a side surface of the receiving slot away from the accommodating space, the stopping block is located at an upper side of the engaging sheet to stop the engaging sheet from moving upward, a protruding block is protrudingly provided at a side of the limiting portion adjacent to the retaining portion, and an upper edge of the cutout stops an upper end of the protruding block. In certain embodiments, the shielding portion shields a top portion of the receiving slot and a lower surface of the shielding portion abuts against an upper surface of the mounting portion, a rear edge of the shielding portion does not pass backward beyond a range of a rear edge of the mounting portion, and edges at a left side and a right side of the shielding portion do not pass beyond ranges of edges at a left side and a right side of the mounting portion.

In certain embodiments, the elastic arm, the connecting portion and the retaining portion collectively form a U-shaped structure with an opening at an upper end thereof, and the limiting portion is inserted downward into the opening and located between the retaining portion and the elastic arm. These and other aspects of the present invention will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the disclosure and together with the written description, serve to explain the principles of the disclosure. Wherever possible, the same reference numbers are used throughout the drawings to refer to the same or like elements of an embodiment, and wherein:

FIG. 1 is a perspective exploded view of a battery holder according to a first embodiment of the present invention.

FIG. 2 is a perspective schematic view of the battery holder according to the first embodiment of the present invention.

FIG. 3 is a top view of the battery holder according to the first embodiment of the present invention.

FIG. 4 is a sectional view of FIG. 3 along a direction A-A.

FIG. 5 is a sectional view of FIG. 3 along a direction B-B.

FIG. 6 is a schematic view of a plug of the battery holder according to the first embodiment of the present invention being 180° inversed.

FIG. 7 is a perspective schematic view of a battery holder according to a second embodiment of the present invention.

FIG. 8 is a top view of the battery holder according to the second embodiment of the present invention.

FIG. 9 is a sectional view of FIG. 8 along a direction C-C.

FIG. 10 is a top view of the battery holder according to the second embodiment of the present invention after the battery is mounted.

FIG. 11 is a sectional view of FIG. 10 along a horizontal direction.

### DETAILED DESCRIPTION

The present invention is more particularly described in the following examples that are intended as illustrative only since numerous modifications and variations therein will be apparent to those skilled in the art. Various embodiments of the invention are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present invention.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, the terms “comprising”, “including”, “carrying”, “having”, “containing”, “involving”, and the like are to be understood to be open-ended, i.e., to mean including but not limited to.

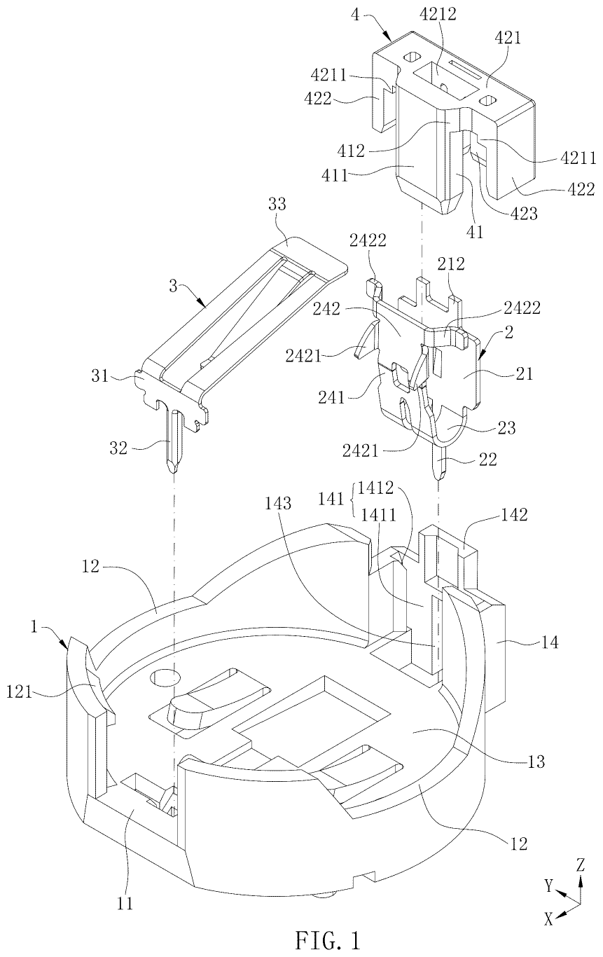

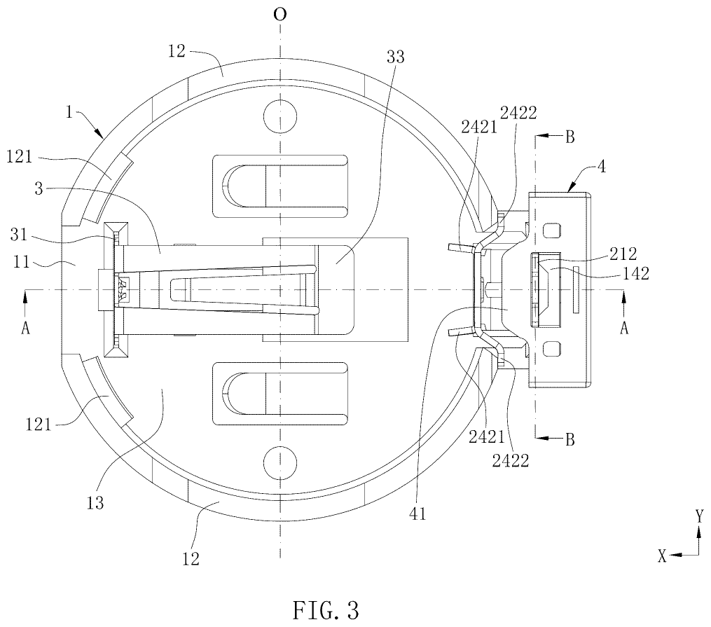

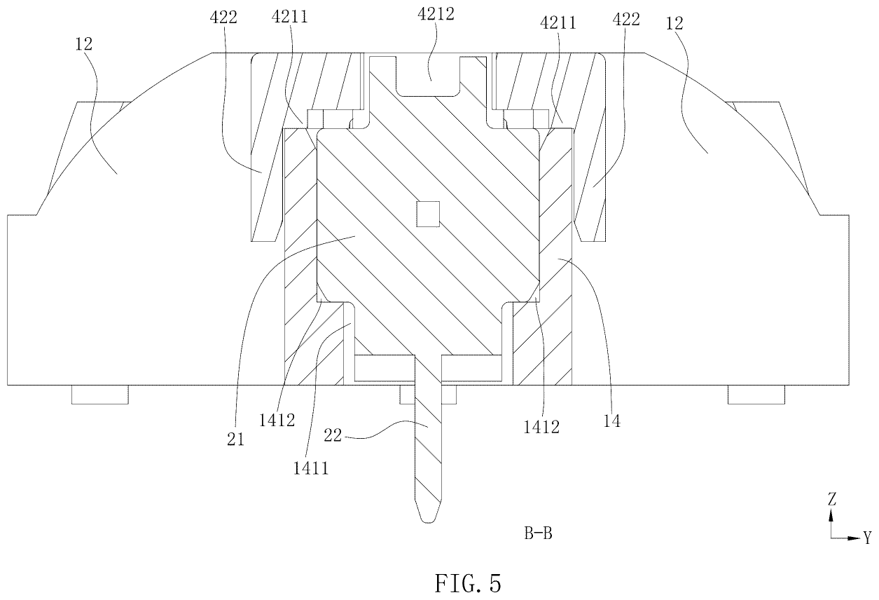

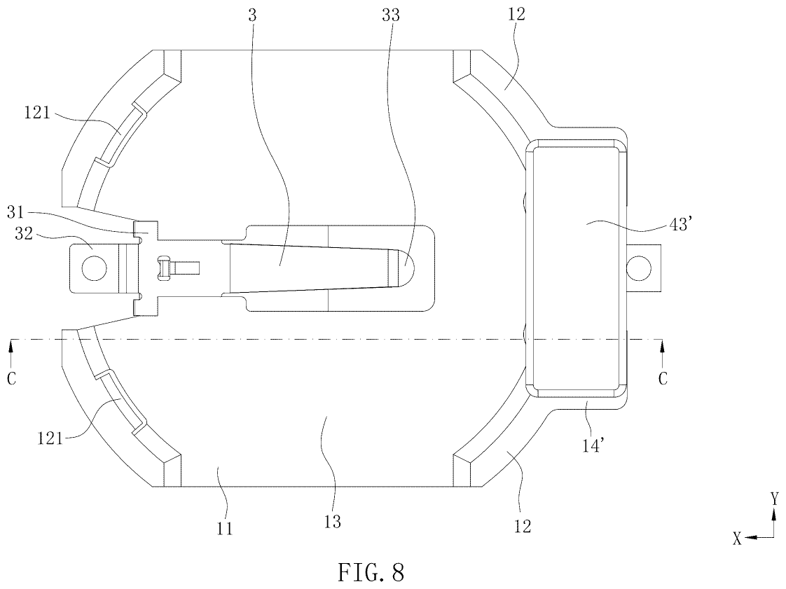

The description will be made as to the embodiments of the present invention in conjunction with the accompanying drawings in FIGS. 1-11. In accordance with the purposes of this invention, as embodied and broadly described herein, this invention, in one aspect, relates to an electrical connector assembly with a battery holder with a plug.

For description accuracy, descriptions of the present invention related to the directions are all referenced to FIG. 1. The term “Z-axis direction” refers to a direction parallel to an insertion direction of a plug, that is, an up-down direction (in which the positive direction of the Z-axis is upward). A direction perpendicular to the insertion direction of the plug is a horizontal direction, and the horizontal direction includes a front-rear direction and a left-right direction perpendicular to each other. The term “X-axis direction” is a direction parallel to a protruding direction of a mounting portion, that is, the front-rear direction (in which the positive direction of the X-axis is forward). The term “Y-axis direction” is the horizontal direction perpendicular to the protruding direction of the mounting portion, that is, the left-right direction (in which the positive direction of the Y-axis is leftward). The X-axis direction, the Y-axis direction and the Z-axis direction collectively form the three orthogonal directions of the battery holder. For convenience of descriptions, the up and down, left and right, and front and rear directions are relative locations, and thus do not limit the implementation thereof. The X-axis direction, the Y-axis direction and the Z-axis direction of the battery holder may be self-defined according to the specific structures of the product and the illustrative viewing angles of the accompanying drawings, and the present invention is not limit thereto.

Referring to FIG. 1 to FIG. 11, in certain embodiments of the present invention, the battery holder is used to accommodate a battery D, and includes a holder body 1 made of an insulating material, a positive elastic sheet 2 and a negative elastic sheet 3 respectively accommodated in the holder body 1 and electrically connected to the battery D, and a plug 4.

FIG. 1 to FIG. 6 show a first embodiment of the present invention. The holder body 1 has a bottom wall 11 and a side wall 12 extending upward from the bottom wall 11 and surrounding the bottom wall 11. The bottom wall 11 and the side wall 12 collectively form an accommodating space 13 to accommodate the battery D. A front side of the side wall 12 is provided with two protruding portions 121 protruding toward the accommodating space 13, and the two protruding portions 121 are located at a top portion of the battery D and abut against an upper surface of the battery D to stop the battery D from moving upward. In the present embodiment, the protruding portions 121 are provided in block shapes. In other embodiments, the protruding portions 121 may be provided as protruding bumps or hooks, or in other shapes which may achieve stopping the battery D from moving upward. In other embodiment, it is also possible to provide only one protruding portion 121 or two or more protruding portions 121, as long as it is possible to achieve the effect of stopping the battery D from moving upward, the present invention does not limit the specific shapes and quantity of the protruding portions 121. A rear side of the side wall 12 is provided with a mounting portion 14 protruding backward, and the mounting portion 14 and the protruding portions 121 are respectively located at two opposite sides of a horizontal central line O of the accommodating space 13. A receiving slot 141 is formed by running through the mounting portion 14 along the vertical direction, and the receiving slot 141 and the protruding portions 121 are respectively located at a front side and a rear side of the accommodating space 13. In the front-rear direction, the receiving slot 14 is in communication with the rear side of the accommodating space 13. In the present embodiment, the receiving slot 141 includes a receiving channel 1411 located at a middle and in communication with the accommodating space 13 and two retaining slots 1412 concavely provided respectively at a left side and a right side of a rear end of the receiving channel 1411 along the left-right direction. A rear wall of the mounting portion 14 away from the accommodating space 13 is provided with a positioning protrusion 142 formed by protruding upward. In the present embodiment, a top surface of the positioning protrusion 142 and a top surface of the highest location of the side wall 12 are flush in the vertical direction. That is, the positioning protrusion 142 does not pass beyond the top end of the side wall 12, which is conducive to saving the space, and satisfying the miniaturization requirement of the electronic equipment. The rear wall of the mounting portion 14 is provided with a locking slot 143 running forward and downward therethrough. The locking slot 143 is in communication with the receiving slot 141, and an upper edge of the locking slot 143 is provided with an oblique surface 1431. The locking slot 143 is located at a lower side of the positioning protrusion 142.

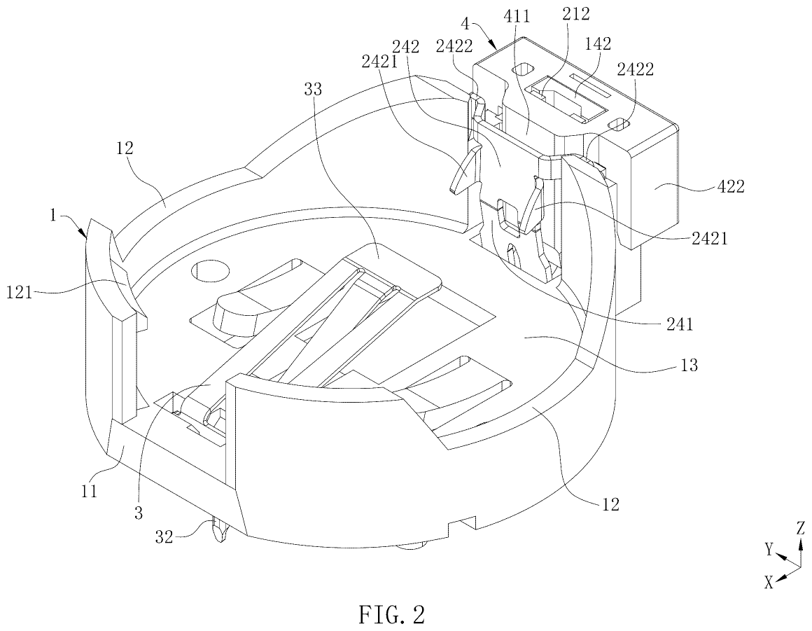

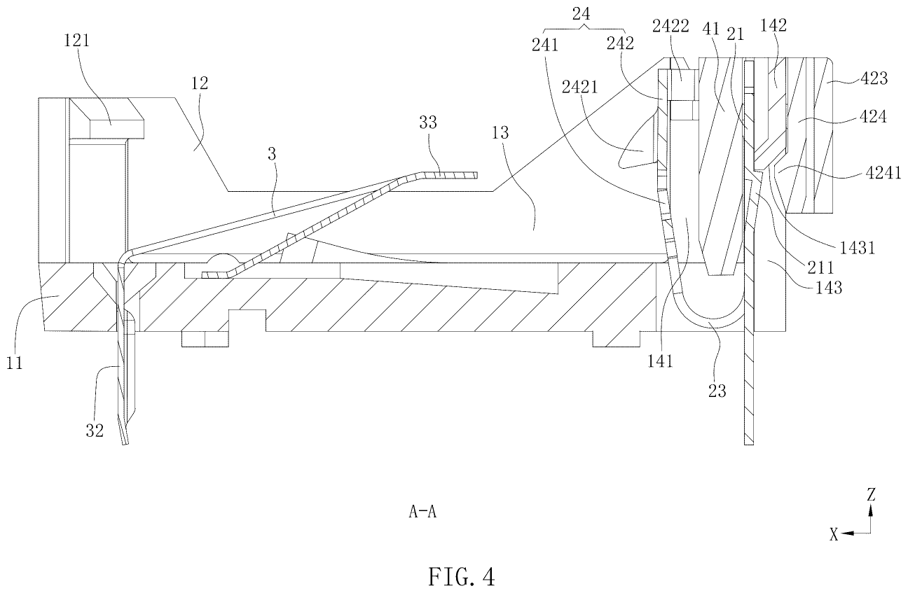

As shown in FIG. 1, FIG. 2 and FIG. 4, the positive elastic sheet 2 and the negative elastic sheet 3 are both fixed to and mounted in the holder body 1. The positive clastic sheet 2 has a retaining portion 21 fixed to and mounted in the receiving slot 141. Specifically, edges at a left side and a right side of the retaining portion 21 of the positive elastic sheet 2 are respectively fixed to the two retaining slots 1412, and a middle portion of the retaining portion 21 is accommodated in a receiving channel 1411. The middle portion of the retaining portion 21 is provided with an extending portion 212 protruding upward. A connecting portion 23 extends from a lower end of the retaining portion 21, and an elastic arm 24 extends upward from a side of the connecting portion 23. The elastic arm 24 and the retaining portion 21 are provided side-by-side in the horizontal direction. The elastic arm 24 is located at a front side of the retaining portion 21 and is exposed to the accommodating space 13. The elastic arm 24, the connecting portion 23 and the retaining portion 21 collectively form a U-shaped structure with an opening at an upper end thereof. The clastic arm 24 has a contact section 241 extending obliquely toward the accommodating space 13 and a limiting section 242 located above the contact section 241. The contact section 241 is used to elastically abut against the side surface of the battery D. A left side edge and a right side edge of the limiting section 242 respectively bend and extend to form two stopping portions 2421. The two stopping portions 2421 are both located at the top portion of the battery D, such that the stopping portions 2421 and the protruding portions 121 collectively stop the battery D from moving upward, thus preventing the battery D from falling from the accommodating space 13. A left side and a right side of a top end of the limiting section 242 respectively bend and extend toward the direction away from the accommodating space 13 to form two blocking sheets 2422. The two blocking sheets 2422 respectively abut against an outer surface of the side wall 12, thus preventing the elastic arm 24 from excessively deviating forward that results in the battery D not to be easily mounted in place. The retaining portion 21 is provided with an engaging sheet 211 extending upward. In the present embodiment, the engaging sheet 211 is formed by tearing from the middle portion of the retaining portion 21 and extending upward. The upper edge of the locking slot 143 is located at an upper side of the engaging sheet 211 to stop the engaging sheet 211 from moving upward. In other embodiments, it is also possible to provide a protruding bump from the rear surface of the retaining portion 21, and the upper edge of the locking slot 143 is located at an upper side of the protruding bump to stop the positive elastic sheet 2 from moving upward. A positive soldering portion 22 extends from one side of the retaining portion 21 to be electrically connected to a circuit board. The negative elastic sheet 3 has a fixing portion 31 mounted on the bottom wall 11 of the holder body 1, a negative contact portion 33 extending from one side of the fixing portion 31 to the accommodating space 13 to be electrically connected to the lower surface of the battery D, and a negative soldering portion 32 extending from another side of the fixing portion 31 out of the accommodating space 13 to be electrically connected to the circuit board.

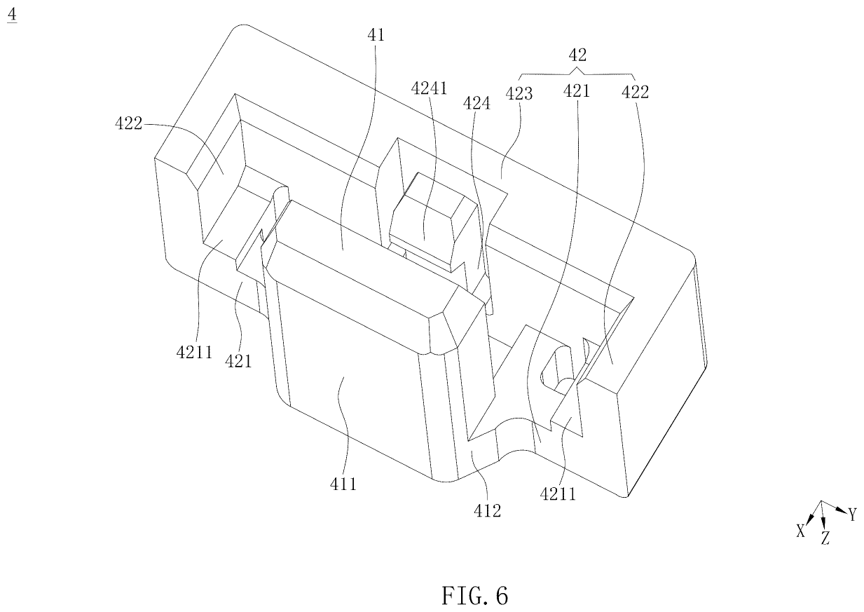

As shown in FIG. 1, FIG. 4 and FIG. 6, the plug 4 is made of an insulating material, and plug 4 has a limiting portion 41 extending along vertical direction and a frame portion 42 located at a rear side of the limiting portion 41. The limiting portion 41 has a first limiting surface 411 and two second limiting surfaces 412 located at a left side and a right side of the first limiting surface 411. A front side of the frame portion 42 is connected to the limiting portion 41. The frame portion 42 has a top plate 421, two side plates 422 extending downward from a left side and a right side of the top plate 421, and a rear plate 423 connected to the two side plates 422. Each of two sides of the top plate 421 is provided with an abutting protrusion 4211 protruding downward, and a top surface of the top plate 421 is provided with a positioning slot 4212 running downward therethrough. The top plate 421 is provided with a locking arm 424 extending downward and a locking hook 4241 protruding forward from a lower end of the locking arm 424. The limiting portion 41 extends downward from a front side of the top plate 421 and is provided to directly face the locking arm 424. The rear plate 423 is located at a rear side of the locking arm 424 and a gap exists between the rear plate 423 and the locking arm 424. An extending length of the rear plate 423 in the up-down direction is greater than or equal to an extending length of the locking arm 424 in the up-down direction.

As shown in FIG. 2 to FIG. 5, after the battery D is mounted in the accommodating space 13 (the battery D not shown in FIG. 2-5), the plug 4 is inserted in and mounting to the mounting portion 14 of the holder body 1, and the limiting portion 41 is inserted downward and located between the retaining portion 21 and the elastic arm 24 from the opening of the U-shaped structure, that is, the limiting portion 41 is inserted downward into a space collectively defined by the retaining portion 21 and the clastic arm 24 along the front-rear direction, thus preventing the limiting portion 41 from additionally increasing the volume of the battery holder, which is conducive to saving the space, and satisfying the miniature requirement of the electronic equipment. On the other hand, the limiting portion 41 is located on an extending line of the path along which the clastic arm 24 provides a normal force to the battery D. The limiting portion 41 stops the clastic arm 24 from excessively deviating toward the direction away from the battery D, thus retaining the battery D in the accommodating space 13, preventing the elastic arm 24 from being accidentally deflected by the children or excessively deviating toward the direction away from the battery D in a high vibration environment that results in the two stopping portions 2421 to follow the elastic arm 24 to move and become ineffective in the effect of stopping the battery D, and preventing the battery D from losing the stopping of the stopping portion 2421 and falling from the accommodating space 13, preventing the children from accidental ingestion of the battery D, and ensuring the structural stability of the battery holder. Further, by maintaining the original structure of the positive elastic sheet 2, the function of stopping the battery D may be achieved, without the need of designing a new manufacturing mold, which is conducive to saving the cost. The limiting portion 41 and the protruding portions 121 are respectively located at two opposite sides of a horizontal central line O of the accommodating space 13. Before the mounting of the battery D, a gap exists between the retaining portion 21 and the elastic arm 24, and the contact section 241 is provided on the elastic arm 24. Thus, the elastic arm 24 may have proper deviation to allow the battery D to be mounted in place. Further, as shown in FIG. 4, after the limiting portion 41 is inserted downward into the space between the retaining portion 21 and the elastic arm 24, a gap exists between the contact section 241 and the limiting portion 41, thus preventing the limiting portion 41 from abutting against the contact section 241 in the inserting process that may result in elastic fatigue or deviation damages of the contact section 241, such that the contact section 241 has a sufficient normal force that maintains elastically abutting against the battery D, ensuring the stability of the electrical connection between the contact section 241 and the battery D. After the battery D is mounted in the accommodating space 13 (the battery D not shown in figures), if the collision due to an external force or an accidental touching by the children occurs, the elastic arm 24 moves toward the limiting portion 41, such that the gap between the limiting portion 41 and the elastic arm 24 is eliminated, and the limiting portion 41 may stop the elastic arm 24 from excessively deviating backward. Thus, the limiting portion 41 may effectively ensure that the elastic arm 24, even under the condition of collision due to the external force or the accidental touching by the children, does not excessively deviate, and the stopping portion 2421 stops the battery D. Further, the first limiting surface 411 faces directly toward the limiting section 242, and in the front-rear direction, a maximum distance between the first limiting surface 411 and the limiting section 242 is less than an extending length of each stopping portion 2421 along the horizontal direction, thus ensuring that the elastic arm 24 does not excessively deviate to result in the stopping portion 2421 losing its stopping effect, and ensuring the stopping effect of the limiting portion 41. Further, the two second limiting surfaces 412 face directly toward the two blocking sheet 2422 respectively, and a distance between each second limiting surface 412 and a corresponding blocking sheet 2422 is less than or equal to a distance between the first limiting surface 411 and the limiting section 242. The first limiting surface 411 limits the limiting section 242, and the two second limiting surfaces 412 limit the two blocking sheets 2422, thus ensuring the limiting portion 41 to stop the elastic arm 24 from excessively deviate in various directions, and ensuring the effect of the stopping portion 2421 stopping the battery D. The bottom end of the frame portion 42 has an opening, such that the frame portion 42 sleeves downward outside the mounting portion 14. The two abutting protrusions 4211 abut against the upper surface of the mounting portion 14, thus stopping the plug 4 from moving downward. The outer edges at the left side and the right side of the mounting portion 14 are partially covered by the two side plates 422 to collectively stop the frame portion 42 from moving in the left-right direction. The extending portion 212 of the retaining portion 21 and the positioning protrusion 142 are inserted into the positioning slot 4212 to collectively limit the frame portion 42 in the front-rear direction, thus preventing the plug 4 from moving in the front-rear direction. The left side and the right side of the positioning protrusion 142 may also limit the frame portion 42 in the left-right direction. The upper end and the lower end of the locking hook 4241 are both provided as oblique surfaces. When the plug 4 is mounted to the mounting portion 14, the oblique surface at the lower end of the locking hook 4241 abuts against the rear surface of the positioning protrusion 142, and the oblique surface at the lower end of the locking hook 4241 guides the locking arm 424 to deviate backward. When the plug 4 moves downward and the locking hook 4241 enters the locking slot 143, the recovering force of the locking arm 424 makes the locking arm 424 to deviate forward, such that the oblique surface at the upper end of the locking hook 4241 buckles with the oblique surface 1431 of the locking slot 143, thus preventing the plug 4 from moving upward. The rear plate 423 is located behind the locking arm 424, and a gap exists between the rear plate 423 and the locking arm 424, thus providing a deviating space for the locking arm 424, allowing the locking arm 424 to buckle downward with the oblique surface 1431 of the locking slot 143. In the present embodiment, the lower end of the rear plate 423 and the lower end of the locking arm 424 are flush. That is, an extending length of the rear plate 423 in the up-down direction is equal to an extending length of the locking arm 424 in the up-down direction, thus preventing the locking arm 424 from excessively expand outward in the assembly process that results in the locking arm 424 to break, and preventing the locking arm 424 from accidental contact or collision due to an external force. The rear plate 423 protects the locking arm 424, such that it does not easily detach due to contact by the external force. In other embodiments, the extending length of the rear plate 423 in the up-down direction may also be greater than the extending length of the locking arm 424 in the up-down direction, and the lower end of the rear plate 423 does not pass downward beyond the lower edge of the mounting portion 14, thus preventing the locking arm 424 from excessively expand outward in the assembly process, and preventing from additionally increasing the height of the battery holder.

As shown in FIG. 1, FIG. 2 and FIG. 4, when it is required to take out the battery D, the plug 4 needs to be lifted upward, such that the locking arm 424 deviates backward and the locking hook 4241 detaches from the oblique surface 1431 of the locking slot 143, and the limiting portion 41 retreats from the space between the clastic arm 24 and the retaining portion 21. Then, the elastic arm 24 is operated to deviate backward, such that the stopping portion 2421 loses its stopping effect, and then the battery D is taken out. This step-by-step process makes it difficult for the children to take out the battery D, thus preventing the children from accidental ingestion of the battery D. In addition, a gap exists between the contact section 241 and the limiting portion 41, thus preventing the limiting portion 41 from colliding with the contact section 241 in the pulling process of the plug 4 that may result in elastic fatigue or deviation damages of the contact section 241, thus ensuring that the insertion or pulling of the plug 4 does not affect the elastic abutting effect between the contact section 241 and the battery D, and ensuring the stability of the electrical connection between the contact section 241 and the battery D.

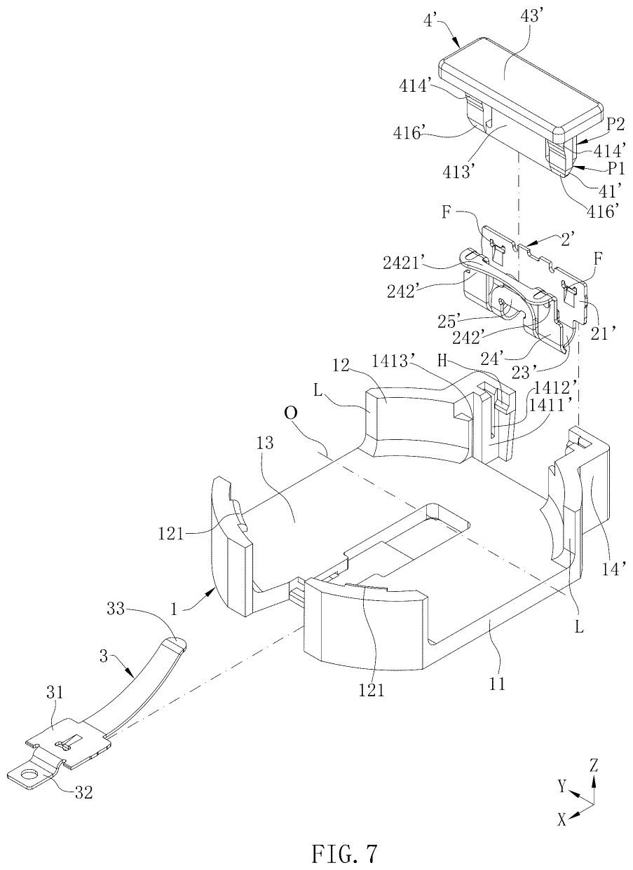

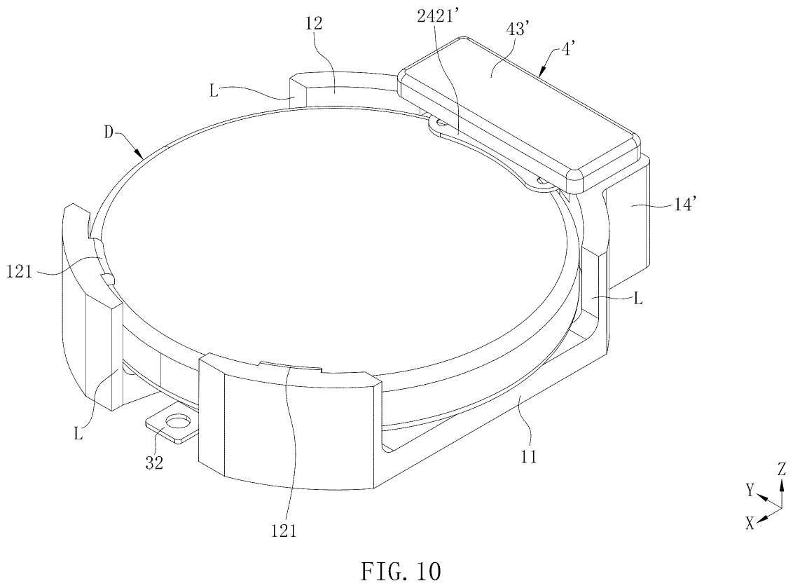

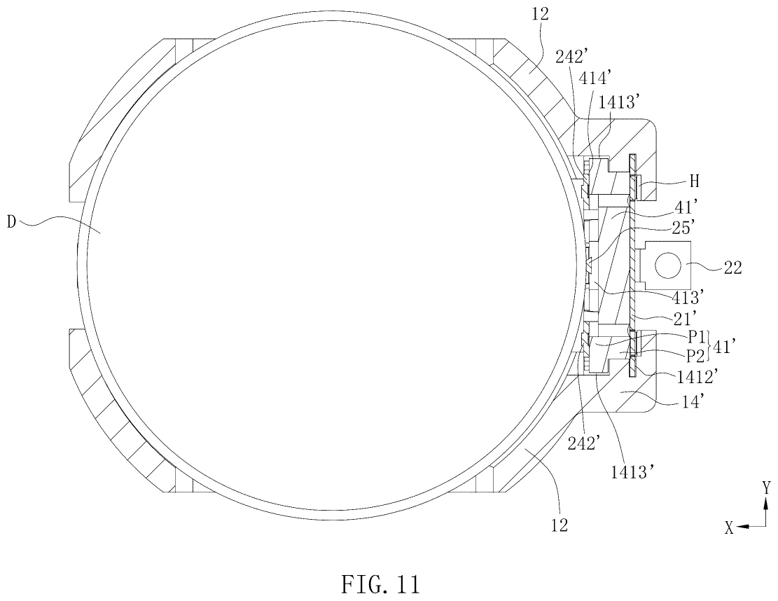

FIG. 7 to FIG. 11 show a battery holder according to a second embodiment of the present invention, and the battery is shown in FIG. 10 and FIG. 11. In the second embodiment, the holder body 1 also has the accommodating space 13 collectively formed by the bottom wall 11 and the side wall 12 to accommodate the battery D. The side wall 12 is also protrudingly provided with the protruding portions 121 to stop the battery D from moving upward, and the side wall 12 protrudes backward to form the mounting portion 14′. The positive elastic sheet 2 and the negative elastic sheet 3 are also fixed and mounting to the holder body 1. The positive elastic sheet 2′ also has the elastic arm 24′, the connecting portion 23′ and the retaining portion 21′ that form a U-shaped structure with an opening at an upper end thereof. The negative elastic sheet 3 also has the fixing portion 31 mounted on the bottom wall 11 of the holder body 1, the negative contact portion 33 extending from one side of the fixing portion 31 to the accommodating space 13 to be electrically connected to the lower surface of the battery D, and the negative soldering portion 32′ extending from another side of the fixing portion 31 out of the accommodating space 13 to be electrically connected to the circuit board. The plug 4′ also has the limiting portion 41′ inserted downward into the space between the retaining portion 21′ and the elastic arm 24′ from the opening of the U-shaped structure to stop the elastic arm 24′ from excessively deviating toward the direction away from the battery D. The limiting portion 41′ is located on an extending line of the path along which the elastic arm 24′ provides a normal force to the battery D, thus retaining the battery D in the accommodating space 13. In the second embodiment, the mounting portion 14′ of the holder body I does not have the positioning protrusion 142, the elastic arm 24′ of the positive elastic sheet 2′ does not have the contact section 241 and the blocking sheet 242, and the plug 4′ does not have the frame portion 42. Specifically, the side wall 12 is provided with a plurality of through slots L running therethrough along the horizontal direction, and the through slots L are provided to break the side wall 12. The receiving slot 141′ includes the receiving channel 1411′ located at a middle and in communication with the accommodating space 13′, two recesses 1413′ concavely provided respectively from a left side and a right side of the front end of the receiving channel 1411′ along the left-right direction, and two retaining slots 1412′ concavely provided at a left side and a right side of the rear end of the receiving channel 1411′ along the left-right direction. The two limiting sections 242′ are one-to-one correspondingly located in the two recesses 1413′, and inner surfaces of front ends of the two recesses 1413′ correspondingly stop the two limiting sections 242′ from deviating toward the accommodating space 13′. Edges at a left side and a right side of the retaining portion 21′ of the positive elastic sheet 2′ are respectively fixed to the two retaining slots 1412′, and a middle portion of the retaining portion 21′ is accommodated in the receiving channel 1411′. Two stopping blocks H are provided to protrude forward from the rear inner surface of the receiving slot 141′. The retaining portion 21′ is provided with two cutouts F running therethrough along the front-rear direction. The lower edge of each cutout F integrally extends upward to form the engaging sheet 211′, and the two stopping blocks H are correspondingly located at an upper side of the two engaging sheets 211′ to stop the engaging sheets 211′ from moving upward, thus preventing the positive elastic sheet 2′ from moving upward. The middle portions of the connecting portion 23′ and the elastic arm 24′ are provided to be hollow, such that two limiting sections 242′ are formed at a left side and a right side of the elastic arm 24′ respectively. A contact spring arm 25′ bends and extends upward from a middle portion of a bottom end of the retaining portion 21′. A portion of the contact spring arm 25′ is located in a hollow region at the middle portions of the connecting portion 23′ and the elastic arm 24′ and extends to the accommodating space 13′ to be electrically connected to the side surface of the battery D. The contact spring arm 25′ and the elastic arm 24′ are provided to be independent from each other, and the contact spring arm 25′ and the elastic arm 24′ are provided at an interval. Thus, the contact spring arm 25′ may freely deviate without being limited by the elastic arm 24′, and when the battery D is mounted, the contact spring arm 25′ may independently deviate, allowing the battery D to be mounted in place. Thus, the limiting portion 41′ and the elastic arm 24′ may abut against each other. Specifically, the limiting portion 41′ of the plug 4′ is provided to be wider at front thereof and narrower at rear thereof. The limiting portion 41′ has a first portion P1 with a wider width and a second portion P2 located at a rear side of the first portion P1 and with a narrower width. A reserved notch 413′ is concavely provided on a surface at the middle portion of the limiting portion 41′ facing the contact spring arm 25′. The limiting portion 41′ forms two abutting surfaces 414′ at a left side and a right side of the reserved notch 413′ respectively, and the two abutting surfaces 414′ are respectively located behind the two limiting sections 242′ to abut against the two limiting sections 242′, thus stopping the elastic arm 24′ from deviating backward, and ensuring the stopping portion 2421′ to effectively stop the battery D. That is, the reserved notch 413′ is backward concavely provided from a front end of the first portion P1, and the two abutting surfaces 414′ are respectively provided at a left side and a right side of the front end of the first portion P1. In the front-rear direction, a thickness of each of the portions of the first portion P1 provided with the two abutting surfaces 414′ is greater than a thickness of the portion of the first portion P1 provided with the reserved notch 413′. The second portion P2 is accommodated in the receiving channel 1411′, and inner surfaces at a left side and a right side of the receiving channel 1411′ collectively stop the second portion P2 from moving in the left-right direction. The lower end of the limiting portion 41′ is provided with a plurality of guiding surfaces 417′. Specifically, the first portion P1 is provided with one of the guiding surfaces 416′ below each abutting surface 414′, and a rear side of a lower end of the second portion P2 is provided with one of the guiding surfaces 416′. The guiding surfaces 416′ collectively guide the limiting portion 41′ to be inserted downward into the space between the retaining portion 21′ and the elastic arm 24′, thus preventing the limiting portion 41′ from colliding with the retaining portion 21′ and the elastic arm 24′ in the inserting process that results in damages of the retaining portion 21′ and the clastic arm 24′. In other embodiments, the lower edge of the rear surface of the reserved notch 413′ may also be provided with a guiding surface 416′ extending obliquely upward, thus preventing the limiting portion 41′ from colliding with the contact spring arm 25′ in the inserting and mounting process that causes the damage of the contact spring arm 25′. In the present embodiment, the guiding surface 416′ is provided as a flat surface obliquely upward. In other embodiments, the guiding surface 416′ may be provided as a curved surface obliquely upward. The front side surface of the retaining portion 21′ and the rear side surface of the limiting portion 41′ abut against each other, thus preventing the limiting portion 41′ from moving backward, and enhancing the stopping force of the limiting portion 41′ to the elastic arm 24′. As shown in FIG. 11, the reserved notch 413′ is located right behind the contact spring arm 25′ to provide the space for the contact spring arm 25′. That is, in the front-rear direction, a gap exists between the surface at a side of the limiting portion 41′ facing toward the contact spring arm 25′ and the contact spring arm 25′, thus preventing the contact spring arm 25′ and the limiting portion 41′ from abutting against each other in the inserting and mounting process of the plug 4′ that results in elastic fatigue or even deviation damages of the contact spring arm 25′, ensuring that the contact spring arm 25′ has a sufficient normal force that maintains elastically abutting against the battery D, and ensuring the stability of the electrical connection between the contact spring arm 25′ and the battery D. The stopping portion 2421′ is formed by bending and extending from the upper end of the elastic arm 24′ toward the accommodating space 13, and the stopping portion 2421′ is located at the top portion of the battery D, such that the stopping portion 2421′ and the protruding portions 121 collectively stop the battery D from moving upward, preventing the battery D from falling from the accommodating space 13. The top end of the plug 4′ has a shielding portion 43′ and the shielding portion 43′ is located above the limiting portion 41′. In the up-down direction, the shielding portion 43′ shields the upper surface of the stopping portion 2421′, such that the children do not easily contact the stopping portion 2421′, thus preventing the children from deflecting the stopping portion 2421′ upward by fingers or with tools that results in failure of the stopping effect. The rear side surface of the limiting portion 41′ is protrudingly provided with two protruding blocks 415′, and the upper edge of the cutout F stops the upper end of the protruding block 415′ to prevent the limiting portion 41′ from moving upward. The shielding portion 43′ shields the top portion of the receiving slot 141′, and the lower surface of the shielding portion 43′ and the upper surface of the mounting portion 14′ abut against each other, thus stopping the plug 4′ from moving downward. A rear edge of the shielding portion 43′ does not pass backward beyond a range of a rear edge of the mounting portion 14′, a front edge of the shielding portion 43′ does not pass forward beyond a range of the side wall 12′ adjacent to the mounting portion 14′, and edges at a left side and a right side of the shielding portion 43′ do not pass beyond ranges of edges at a left side and a right side of the mounting portion 14′, thus preventing the plug 4′ from increasing the volume of the battery holder in the front-rear direction and the left-right direction, which is conducive to saving the space, and satisfying the miniature requirement of the electronic equipment.

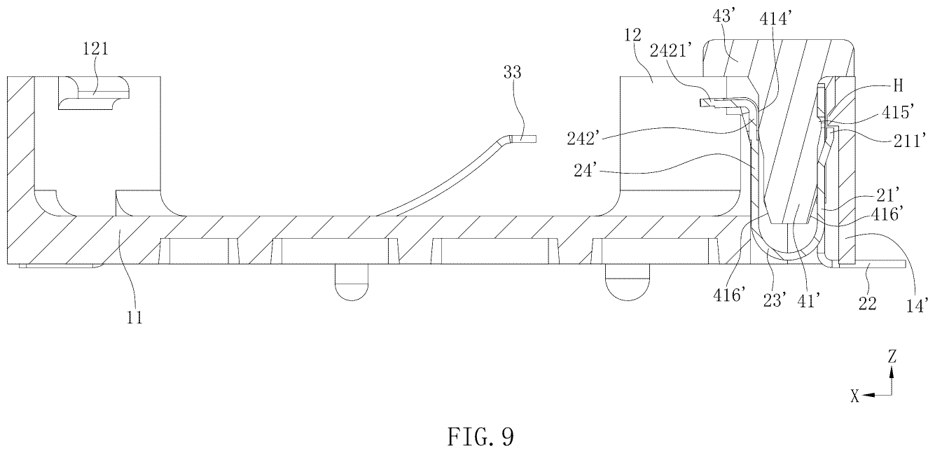

Referring to FIG. 9 and FIG. 10, when it is required to take out the battery D, the plug 4′ needs to be lifted upward, such that the protruding blocks 415′ of the limiting portion 41′ correspondingly detach from the cutouts F of the retaining portion 21′, and the limiting portion 41′ retreats from the space between the elastic arm 24′ and the retaining portion 21′. Then, the battery D is taken out. The step-by-step process makes it difficult for the children to take out the battery D, thus preventing the children from accidental ingestion of the battery D. In addition, a gap exists between the contact spring arm 25′ and the limiting portion 41′ in the front-rear direction, thus preventing the limiting portion 41′ from colliding with the contact spring arm 25′ in the pulling process of the plug 4′ that may result in elastic fatigue or deviation damages of the contact spring arm 25′, thus ensuring that the insertion or pulling of the plug 4′ does not affect the elastic abutting effect between the contact spring arm 25′ and the battery D, and ensuring the stability of the electrical connection between the contact spring arm 25′ and the battery D.

In sum, the battery holder according to certain embodiments of the present invention has the following beneficial effects:
(1) The elastic arm 24 (24′), the connecting portion 23 (23′) and the retaining portion 21 (21′) collectively form a U-shaped structure with an opening at an upper end thereof, and the limiting portion 41 (41′) of the plug 4 (4′) is inserted downward into the space between the retaining portion 21 (21′) and the elastic arm 24 (24′), thus preventing the limiting portion 41 (41′) from additionally increasing the volume of the battery holder, which is conducive to saving the space, and satisfying the miniature requirement of the electronic equipment. A gap exists between the limiting portion 41 (41′) and the contact section 241 (contact spring arm 25′), thus preventing the plug 4 (4′) from colliding with the contact section 241 (contact spring arm 25′) in the inserting or pulling process that may result in elastic fatigue or deviation damages of the contact section 241 (contact spring arm 25′), such that the contact section 241 (contact spring arm 25′) has a sufficient normal force that maintains elastically abutting against the battery D, ensuring the stability of the electrical connection between the contact section 241 (contact spring arm 25′) and the battery D. In addition, the limiting portion 41 (41′) is located on an extending line of the path along which the elastic arm 24 (24′) provides a normal force to the battery D. The limiting portion 41 (41′) stops the elastic arm 24 (24′) from excessively deviating toward the direction away from the battery D, thus retaining the battery D in the accommodating space 13, preventing the elastic arm 24 (24′) from being accidentally deflected by the children or excessively deviating toward the direction away from the battery D in a high vibration environment that results in the stopping portion 2421 (2421′) to follow the elastic arm 24 (24′) to move and become ineffective in the effect of stopping the battery D, and preventing the battery D from losing the stopping of the stopping portion 2421 (2421′) and falling from the accommodating space 13, preventing the children from accidental ingestion of the battery D, and ensuring the structural stability of the battery holder. Further, by maintaining the original structure of the positive elastic sheet 2 (2′), the function of stopping the battery D may be achieved, without the need of designing a new manufacturing mold, which is conducive to saving the cost.
(2) In the front-rear direction, a maximum distance between the first limiting surface 411 and the limiting section 242 is less than an extending length of each stopping portion 2421 along the horizontal direction, thus ensuring that the elastic arm 24 does not excessively deviate to result in the stopping portion 2421 losing its stopping effect, and ensuring the stopping effect of the limiting portion 41. The two second limiting surfaces 412 face directly toward the two blocking sheets 2422 respectively, and a distance between each second limiting surface 412 and a corresponding blocking sheet 2422 is less than or equal to a distance between the first limiting surface 411 and the limiting section 242. The first limiting surface 411 limits the limiting section 242, and the two second limiting surfaces 412 limit the two blocking sheets 2422, thus ensuring the limiting portion 41 to stop the elastic arm 24 from excessively deviating in various directions, and ensuring the effect of the stopping portion 2421 stopping the battery D.
(3) The two abutting protrusions 4211 abut against the upper surface of the mounting portion 14, thus stopping the plug 4 from moving downward. The outer edges at the left side and the right side of the mounting portion 14 are partially covered by the two side plates 422 to collectively stop the frame portion 42 from moving in the left-right direction. The extending portion 212 and the positioning protrusion 142 are inserted into the positioning slot 4212 to collectively limit the frame portion 42 in the front-rear direction, thus preventing the plug 4 from moving in the front-rear direction. The left side and the right side of the positioning protrusion 142 may also limit the frame portion 42 in the left-right direction.
(4) The oblique surface at the upper end of the locking hook 4241 guides the locking hook 4241 to buckle with the oblique surface 1431 of the locking slot 143, thus preventing the plug 4 from moving upward. The rear plate 423 is located behind the locking arm 424 and shields the surface at a side of the locking arm 424 away from the receiving slot 141 in the horizontal direction, and a gap exists between the rear plate 423 and the locking arm 424, thus providing a deviating space for the locking arm 424, allowing the locking arm 424 to buckle downward with the oblique surface 1431 of the locking slot 143. In addition, the extending length of the rear plate 423 in the up-down direction is greater than or equal to the extending length of the locking arm 424 in the up-down direction, thus preventing the locking arm 424 from excessively expand outward in the assembly process that results in the locking arm 424 to break, and preventing the locking arm 424 from accidental contact or collision due to an external force. The rear plate 423 protects the locking arm 424, such that the locking arm 424 does not easily detach due to contact by the external force.
(5) A rear edge of the shielding portion 43′ does not pass backward beyond range of a rear edge of the mounting portion 14′, and edges at a left side and a right side of the shielding portion 43′ do not pass beyond ranges of edges at a left side and a right side of the mounting portion 14′, thus preventing the plug 4′ from increasing the volume of the battery holder in the front-rear direction and the left-right direction, which is conducive to saving the space, and satisfying the miniature requirement of the electronic equipment.
(6) In the up-down direction, the shielding portion 43′ shields the upper surface of the stopping portion 2421′, such that the children do not easily contact the stopping portion 2421′, thus preventing the children from deflecting the stopping portion 2421′ upward by fingers or with tools that results in failure of the stopping effect.
(7) The upper edge of the cutout F stops the upper end of the protruding block 415′ to prevent the plug 4′ from moving upward. The shielding portion 43′ shields the top portion of the receiving slot 141, and the lower surface of the shielding portion 43′ and the upper surface of the mounting portion 14 abut against each other, thus stopping the plug 4′ from moving downward. The two abutting surfaces 414′ respectively abut against the two limiting sections 242′ to stop the elastic arm 24′ from deviating backward, thus ensuring the effect of the stopping portion 2421′ to stop the battery D. The front side surface of the retaining portion 21′ and the rear side surface of the limiting portion 41′ abut against each other, thus preventing the limiting portion 41′ from moving backward, and enhancing the stopping force of the limiting portion 41′ to the elastic arm 24′. The reserved notch 413′ is located right behind the contact spring arm 25′ to provide the space for the contact spring arm 25′, thus preventing the contact spring arm 25′ and the limiting portion 41′ from abutting against each other that results in deviation of the contact spring arm 25′ and the battery D not being easily mounted in place.
(8) To separate the battery D and the holder body 1, the plug 4 (4′) needs to firstly retreat from the space between the elastic arm 24 (24′) and the retaining portion 21 (21′), and the elastic arm 24 (24′) is operated to deviate backward, such that the stopping portion 2421 (2421′) cannot stop the battery D, and the battery D may be taken out. This step-by-step process makes it difficult for the children to take out the battery D, thus preventing the children from accidental ingestion of the battery D.
(9) The first portion PI is provided with one of the guiding surfaces 416′ below each abutting surface 414′, and a rear side of a lower end of the second portion P2 is provided with one of the guiding surfaces 416′. The guiding surfaces 416′ collectively guide the limiting portion 41′ to be inserted downward into the space between the retaining portion 21′ and the elastic arm 24′, thus preventing the limiting portion 41′ from colliding with the retaining portion 21′ and the elastic arm 24′ in the inserting process that results in damages of the retaining portion 21′ and the elastic arm 24′.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A battery holder, configured to accommodate a battery, the battery holder comprising:
a holder body, having a bottom wall and a side wall extending upward from the bottom wall and surrounding the bottom wall, wherein the bottom wall and the side wall collectively form an accommodating space to accommodate the battery, the holder body is provided with a receiving slot along an up-down direction, and the receiving slot is in communication with the accommodating space;
a positive elastic sheet and a negative elastic sheet, respectively accommodated in the holder body and electrically connected to the battery, wherein the positive elastic sheet comprises a retaining portion fixed in the receiving slot, a connecting portion connected to a lower end of the retaining portion and an elastic arm extending upward from the connecting portion, the elastic arm is exposed in the accommodating space, the retaining portion is located at a side of the elastic arm away from the accommodating space, the elastic arm is provided with at least one stopping portion extending toward the accommodating space, the stopping portion stops the battery from moving upward, the elastic arm has a contact section, and the contact section extends obliquely toward the accommodating space to elastically abut against the battery; and
a plug, having a limiting portion, wherein the limiting portion is inserted downward into a space between the retaining portion and the elastic arm, in a horizontal direction, a gap exists between the limiting portion and the contact section, and the limiting portion is configured to stop the elastic arm from excessively deviating toward a direction away from the battery, and to retain the battery in the accommodating space.

2. The battery holder according to claim 1, wherein a side of the side wall is provided with at least one protruding portion protruding toward the accommodating space, the protruding portion and the limiting portion are respectively located at two opposite sides of a horizontal central line of the accommodating space, and the protruding portion stops the battery from moving upward together with the stopping portion.

3. The battery holder according to claim 1, wherein the elastic arm has a limiting section located above the contact section, the limiting section is limited by the limiting portion, two opposite side edges of the limiting section bend and extend to form two stopping portions to collectively stop the top portion of the battery, and in the horizontal direction, a maximum distance between the limiting portion and the limiting section is less than an extending length of each of the stopping portions along the horizontal direction.

4. The battery holder according to claim 3, wherein each of two sides of a top end of the limiting section respectively bends and extends toward the direction away from the accommodating space to form a blocking sheet, the two blocking sheets respectively abut against an outer surface of the side wall, the limiting portion has a first limiting surface and two second limiting surfaces, the first limiting surface faces directly toward the limiting section, the two second limiting surfaces respectively face directly toward the two blocking sheets, and in the horizontal direction, a distance between each second limiting surface and a corresponding blocking sheet is less than or equal to a distance between the first limiting surface and the limiting section.

5. The battery holder according to claim 1, wherein the retaining portion protrudes upward to form an extending portion, a rear side of the side wall is provided with a mounting portion protruding backward, the receiving slot is formed by running through the mounting portion along the up-down direction, the plug has a frame portion with a opening at a bottom end thereof, a front side of the frame portion is connected to the limiting portion, the frame portion is mounted downward and sleeved outside the mounting portion, each of two sides of the frame portion is provided with an abutting protrusion protruding downward to abut against an upper surface of the mounting portion, outer edges at a left side and a right side of the mounting portion collectively stop the frame portion from moving in a left-right direction, a top surface of the frame portion is provided with a positioning slot running downward therethrough, a rear wall of the mounting portion is provided with a positioning protrusion formed by protruding upward, and the extending portion and the positioning protrusion are both inserted into the positioning slot to collectively limit the frame portion in a front-rear direction.

6. The battery holder according to claim 5, wherein the rear wall of the mounting portion is provided with a locking slot running forward and downward therethrough, the locking slot is in communication with the receiving slot, an upper edge of the locking slot is provided with an oblique surface, the retaining portion is provided with an engaging sheet extending upward, the upper edge of the locking slot is located at an upper side of the engaging sheet to stop the engaging sheet from moving upward, an inner side of the frame portion is provided with a locking arm extending downward and a locking hook protruding forward from a lower end of the locking arm, and the locking hook buckles with the oblique surface.

7. The battery holder according to claim 6, wherein the frame portion has a top plate, two side plates extending downward from the top plate and a rear plate connecting the two side plates, the limiting portion extends downward from a front side of the top plate and is provided to directly face the locking arm, the rear plate is located at a rear side of the locking arm and a gap exists between the rear plate and the locking arm, and an extending length of the rear plate in the up-down direction is greater than or equal to an extending length of the locking arm in the up-down direction.

8. The battery holder according to claim 1, wherein the elastic arm, the connecting portion and the retaining portion collectively form a U-shaped structure with an opening at an upper end thereof, and the limiting portion is inserted downward into the opening and located between the retaining portion and the elastic arm.

9. A battery holder, configured to accommodate a battery, the battery holder comprising:
a holder body, having a bottom wall and a side wall extending upward from the bottom wall, wherein the bottom wall and the side wall collectively form an accommodating space to accommodate the battery, the side wall is protrudingly provided with a mounting portion toward a direction away from the accommodating space, the mounting portion is provided with a receiving slot running therethrough along an up-down direction, and the receiving slot is in communication with the accommodating space;
a positive elastic sheet and a negative elastic sheet, respectively accommodated in the holder body and electrically connected to the battery, wherein the positive elastic sheet comprises a retaining portion fixed in the receiving slot, a connecting portion connected to a lower end of the retaining portion and an elastic arm extending upward from the connecting portion, the elastic arm is exposed in the accommodating space, the retaining portion is located at a side of the elastic arm away from the accommodating space, the elastic arm is provided with a stopping portion extending toward the accommodating space, the stopping portion stops the battery from moving upward, a contact spring arm bends and extends from the retaining portion, and the contact spring arm is exposed to the accommodating space to elastically abut against a side surface of the battery; and
a plug, having a limiting portion, wherein the limiting portion is inserted downward into a space between the retaining portion and the elastic arm, the limiting portion is configured to stop the elastic arm from excessively deviating toward a direction away from the battery, and to retain the battery in the accommodating space, and a reserved notch is concavely provided on a surface of the limiting portion facing the contact spring arm to provide a space for the contact spring arm.

10. The battery holder according to claim 9, wherein a side of the side wall is provided with at least one protruding portion protruding toward the accommodating space, the protruding portion and the mounting portion are respectively located at two opposite sides of a horizontal central line of the accommodating space, and the protruding portion stops the battery from moving upward together with the stopping portion.

11. The battery holder according to claim 9, wherein middle portions of the connecting portion and the elastic arm are provided to be hollow, such that two limiting sections are formed respectively at a left side and a right side of the elastic arm, the contact spring arm bends and extends upward from a middle portion of a bottom end of the retaining portion, a portion of the contact spring arm is located in a hollow region at the middle portions of the connecting portion and the elastic arm, the limiting portion forms two abutting surfaces respectively at a left side and a right side of the reserved notch, and the two abutting surfaces respectively abut against the two limiting sections.

12. The battery holder according to claim 11, wherein the receiving slot comprises a receiving channel located at a middle and in communication with the accommodating space, two recesses concavely provided at a left side and a right side of a front end of the receiving channel along a left-right direction respectively, and two retaining slots concavely provided at a left side and a right side of a rear end of the receiving channel along the left-right direction, the two limiting sections are one-to-one correspondingly located in the two recesses, inner surfaces of front ends of the two recesses correspondingly stop the two limiting sections from deviating toward the accommodating space, a middle portion of the retaining portion is accommodated in the receiving channel, and edges at a left side and a right side of the retaining portion are respectively fixed to the two retaining slots.

13. The battery holder according to claim 12, wherein the limiting portion is provided to be wider at front thereof and narrower at rear thereof, the limiting portion has a first portion with a wider width and a second portion located at a rear side of the first portion and with a narrower width, the reserved notch is backward concavely provided from a front end of the first portion, the two abutting surfaces are respectively located at a left side and a right side of the front end of the first portion, the second portion is accommodated in the receiving channel, and inner surfaces at a left side and a right side of the receiving channel collectively stop the second portion from moving in the left-right direction.

14. The battery holder according to claim 13, wherein a lower end of the limiting portion has a plurality of guiding surfaces obliquely upward, the first portion is provided with one of the guiding surfaces below each of the abutting surfaces, a side of a lower end of the second portion toward the retaining portion is provided with one of the guiding surfaces, and the guiding surfaces collectively guide the limiting portion to be inserted between the retaining portion and the elastic arm.

15. The battery holder according to claim 9, wherein the stopping portion is formed by bending and extending from an upper end of the elastic arm toward the accommodating space, a top end of the plug has a shielding portion, the shielding portion is located above the limiting portion, and in the up-down direction, the shielding portion shields an upper surface of the stopping portion.

16. The battery holder according to claim 15, wherein a rear side of the side wall is provided with the mounting portion protruding backward, the receiving slot is formed by running through the mounting portion along the up-down direction, the retaining portion is provided with a cutout running therethrough along the horizontal direction, an engaging sheet integrally extends upward from a lower edge of the cutout, a stopping block is protrudingly provided on a side surface of the receiving slot away from the accommodating space, the stopping block is located at an upper side of the engaging sheet to stop the engaging sheet from moving upward, a protruding block is protrudingly provided at a side of the limiting portion adjacent to the retaining portion, and an upper edge of the cutout stops an upper end of the protruding block.

17. The battery holder according to claim 15, wherein the shielding portion shields a top portion of the receiving slot and a lower surface of the shielding portion abuts against an upper surface of the mounting portion, a rear edge of the shielding portion does not pass backward beyond a range of a rear edge of the mounting portion, and edges at a left side and a right side of the shielding portion do not pass beyond ranges of edges at a left side and a right side of the mounting portion.

18. The battery holder according to claim 9, wherein the elastic arm, the connecting portion and the retaining portion collectively form a U-shaped structure with an opening at an upper end thereof, and the limiting portion is inserted downward into the opening and located between the retaining portion and the elastic arm.
